(19) United States
(12) Patent Application Publication
(10) Pub. No.: US 2008/0307485 A1
(43) Pub. Date: Dec. 11, 2008

(54) Automatic extension of recording using in-band and out-of-band data sources

(75) Inventors: Sam Clement, Kirkland, WA (US); Todd San Jule, Woodinville, WA (US); Mark Young, Redmond, WA (US); Michael Arnquist, Woodinville, WA (US); Zach Johnson, Woodinville, WA (US); Lee Acton, Kirkland, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/810,218

(22) Filed: Jun. 5, 2007

(51) Int. Cl. H04N 7/16

(52) U.S. Cl. 725/152

(57) ABSTRACT

Multiple data inputs, to a recording device, including out-of-band data, are used in order to dynamically adjust the start and end times for recordings. These data inputs may include published program schedules, electronic program guide data, real-time data feeds, in-band data markers, and real-time services. In advance of and during an event recording, the media recorder monitors real-time data and determines whether the event will start early, start late, end early, or run past the initial scheduled duration. The media recorder may seek out other scheduled recordings for potential conflicts. If no conflicts are found, the media recorder automatically extends or contracts the length of the recording. If conflicts are found, the media recorder attempts to resolve the conflicts based upon priority designations, heuristics, or additional user input to determine whether to alter the scheduled recording session, for example, by extending the duration of the recording period or switching the recording function to a another scheduled program.

### BACKGROUND

Recording broadcasts of programs on a predetermined schedule is inherently flawed, as the actual start and end times of those programs do not always match the scheduled start and end times. The most prominent examples are live events, including sporting events, concerts, award shows, political speeches, and other special events. However programs based on prerecorded events can also be delayed or preempted by various circumstances, such as political addresses or breaking news. Typically there is a published schedule or guide available with estimated start and end times for broadcast programs. When consumers attempt to record this broadcast media they generally adhere to this published schedule data.

Often consumers attempt to estimate a safety buffer before and after the scheduled event in order to capture the entire actual event. For example, a consumer wants to record a specific sporting event. The consumer knows the scheduled start and end time from published schedule data or an electronic program guide. Realizing that sporting events sometimes run late with extra innings or overtime periods, the consumer sets a recording device to start at the scheduled start time and end 30 minutes past the scheduled end time. If the event runs under this estimated end time, the user has recorded too much (wasted tape or space on a DVR), and if the event runs past this estimated end time, the user misses the end of the event.

### SUMMARY

To address this problem, multiple data inputs to the recording device may be used in order to dynamically adjust the start and end times for recordings. These data inputs may include, but are not limited to published program schedules, electronic program guide data, real-time data feeds, in-band data markers, and real-time services (e.g., from media distributors). As one example of an implementation, when a consumer wants to record a specific live event, the live event may be selected for recording through a user interface (UI) in the media recorder. In advance of and during the event recording, the media recorder monitors real-time data and determines whether the event will start early, start late, end early, or run past the initial scheduled duration. The media recorder may seek out other scheduled recordings for potential conflicts. If no conflicts are found, the media recorder automatically extends or contracts the length of the live event recording. If conflicts are found, the media recorder attempts to resolve the conflicts based upon priority designations, heuristics, or additional user input to determine whether to alter the scheduled recording session, for example, by extending the duration of the event recording or switching the recording function to a another scheduled program.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following more particular written Detailed Description of various embodiments and implementations as further illustrated in the accompanying drawings and defined in the appended claims.

### BRIEF DESCRIPTION OF THE DRAWINGS

FIG. 1 is a schematic diagram of a home entertainment system for providing automatic extension of recording of broadcast programming beyond a scheduled duration.

FIG. 2 is a schematic diagram of an implementation of a media recorder and related connections for providing automatic extension of recording of broadcast programming.

FIG. 3 is a schematic diagram of in-band and out-of-band sources for providing information to determine whether to extend the duration of a recording of programming beyond the scheduled end time.

FIG. 4 is a flow diagram of an exemplary implementation of program recording process that determines whether to extend the duration of the recording period beyond the scheduled end time.

FIG. 5 is a schematic diagram of an exemplary general purpose computer that may be embodied within a media server or media recorder to direct the automatic extension of a scheduled recording period.

### DETAILED DESCRIPTION

A system and corresponding process for dynamically adjusting the recording of broadcast media may be realized through the monitoring of multiple data inputs, both in-band and out-of-band. The system aids a consumer attempting to record an event that could start earlier or later, and end earlier or later, than initially scheduled by automatically extending the recording duration if such conditions actually occur. The terms “extend,” “extension,” and “extending” when used generally herein, are intended to encompass any of these possibilities, i.e., starting or ending a recording either earlier or later than an initially schedule time. Recording to meet any combination of these conditions is possible, but the most useful and most likely scenario is when a program starts at scheduled time and ends at the later of the scheduled end time or the data-driven end time.

While the primary examples herein revolve around extension of an end time, the possible implementations are not so limited. Advancement or delay of start times and early cessation of recording is contemplated and can be implemented by simple extrapolation of the methods described herein. Further, while the primary examples herein revolve around sporting events, extension of recording of other types of programming both live (e.g., concerts, award shows, political speeches, and other special events) and prerecorded is contemplated.

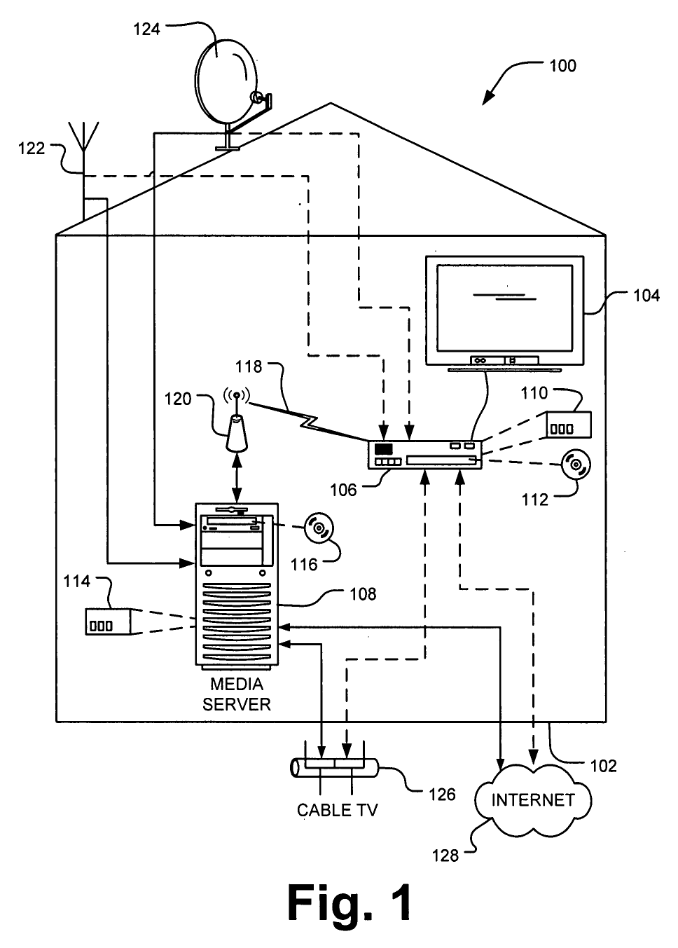

The implementation of automatic recording extension functionality may be understood in the context of a home media network. However, it should be understood that this is only one of many potential implementations, for example, an office computer network, a closed system, a system of special purpose devices, and a standalone device. FIG. 1 depicts an exemplary home entertainment system 100 implemented in a consumer's home 102. A television (TV) 104, a monitor or other presentation device may be attached to a media recorder 106. The media recorder 106 may include one or more tuners (not shown) for directly receiving and recording broadcast transmissions. As shown in the example of FIG. 1, the TV 104 may be coupled to the media recorder 106 through conventional cables. The media recorder 106 may further be connected with a media server 108, either directly or via a communication network 118, for example, a local area network (LAN), as depicted in FIG. 1. In such an embodiment, the media recorder 106 may also function as a media receiver to receive media programming from the media server 108. Media content, including broadcast content, may thus be supplied to the TV 104 over the home network 118 from the media server 108 via the media recorder 106. The media recorder 106 and media server 108 may each also or alternatively be coupled with any of a variety of video and audio presentation devices.

The media recorder 106 may be implemented as any of a variety of conventional media rendering or computing devices, including, for example, a digital video recorder (DVR), a video cassette recorder (VCR), a set-top box, a television, a video gaming console, a desktop PC, a computer server, a notebook or portable computer, a workstation, a mainframe computer, an Internet appliance, a handheld PC, a cellular telephone or other wireless communications device, a personal digital assistant (PDA), or combinations thereof. The media recorder 106 may have memory drives 110 to allow the media recorder 106 to function as a DVR. The media recorder 106 may additionally have an optical disc drive 112 for compact disc (CD) or digital video disc (DVD) media recording or playback.

The communication network 118 may comprise a wired and/or wireless network, for example, cable, Ethernet, WiFi, a wireless access point (WAP), or any other electronic coupling means, including the Internet. The network 118 may enable communication between the media server 108, the media recorder 106, and any other connected device through packet-based communication protocols, such as transmission control protocol (TCP), Internet protocol (IP), real-time transport protocol (RTP), and real-time transport control protocol (RTCP). Communications may be transmitted directly between devices over a LAN, or they may be carried over a wide area network (WAN), for example, the Internet 128.

The media recorder 106 may be configured to receive media content, including video and TV content, directly from a broadcast source, or streamed from the media server 108. Media content, and particularly video and TV content, may be transmitted from the media server 108 to the media recorder 106 as streaming media comprised of discrete content packets via any of the network protocols described above. The streamed media content may comprise video IP, SD, and HD content, including video, audio, and image files, decoded on the media recorder 106 for presentation on the connected TV 104. The media content may further be “mixed” with additional content, for example, an EPG, presentation content related to the media content, a web browser window, and other user interface environments transmitted from the media server 108 for output on the TV 104. Such additional media content may be delivered in a variety of ways using different protocols, including but not limited to, for example, standard remote desktop protocol (RDP), graphics device interface (GDI), or hypertext markup language (HTML).

The media server 108 may be connected with a variety of broadcast media sources, for example, an antenna 122, a satellite receiver 124, a cable connection 126, and/or a network such as the Internet 128. Alternately, the live stream of media content may be received directly by the media recorder 106 as indicated in FIG. 1 or by the TV 104 (not shown), for example, via the antenna 122, the satellite receiver 124, the cable connection 126, or the Internet 128. This capability is enabled by one or more tuners residing in the media recorder 106 and/or the media server 108. In either case, the user may choose a tuner to fit any particular preferences. For example, a user wishing to watch both standard definition (SD) and high definition (HD) content may employ a tuner configured for both types of contents. Alternately, the user may employ an SD tuner for SD content and an HD tuner for HD content separately. Further, multiple tuners may be used by any one device to decode and record multiple media streams simultaneously.

The broadcast media content may be received as an analog signal (e.g., NTSC or PAL) or a digital signal (e.g., DVB, ATSC, or ISDB). The received media content may include discrete content packets, where each content packet includes media content (i.e., audio and video data), policies associated with the actual media content, and metadata identifying or describing the media content. If the media content is received as an analog signal, discrete content packets may be created from the analog signal and metadata or other information may be found in portions of the signal such as the vertical blanking interval.

In one implementation, the media server 108 may be a conventional personal computer (PC) configured to run a multimedia software package, for example, the Windows® XP Media Center Edition operating system (Microsoft Corporation, Redmond Wash.). In such a configuration, the media server 108 is able to integrate full computing functionality with a complete home entertainment system into a single PC. For example, a user can watch TV in one graphical window of a video monitor, while sending email or working on a spreadsheet in another graphical window on the same monitor. In addition, the media server 108 may also include other features or components, for example: a personal video recorder (PVR) to capture live TV shows for future viewing or to record the future broadcast of a single program or series; a memory drive 114 for integrated storage of and access to a user's recorded content, such as TV shows, songs, pictures, a CD or DVD drive 116 for disc media playback; and home videos; and an electronic program guide (EPG).

Instead of a conventional PC, the media server 108 may comprise a variety of other devices capable of storing and distributing media content including, for example, a notebook or portable computer, a tablet PC, a workstation, a mainframe computer, a server, an Internet appliance, or combinations thereof. The media server 108 may also be a set-top box capable of delivering media content to a computer where it may be streamed, or the set-top box itself could stream the media content. As the media server 108 may be a full function computer running an operating system, the user may also have the option to run standard computer programs (e.g., word processing and spreadsheets), send and receive emails, browse the Internet, or perform other common functions.

In addition to the media recorder 108 and the media recorder 106, the media server 108 may be connected with other peripheral devices, including components such as DVRs, cable or satellite set-top boxes, speakers, and a printer (not shown for the sake of graphic clarity). The media server 108 may also enable multi-channel output for speakers. This may be accomplished through the use of digital interconnect outputs, such as Sony-Philips Digital Interface Format (S/PDIF) or TOSLINK® enabling the delivery of Dolby Digital, Digital Theater Sound (DTS), or Pulse Code Modulation (PCM) surround decoding.

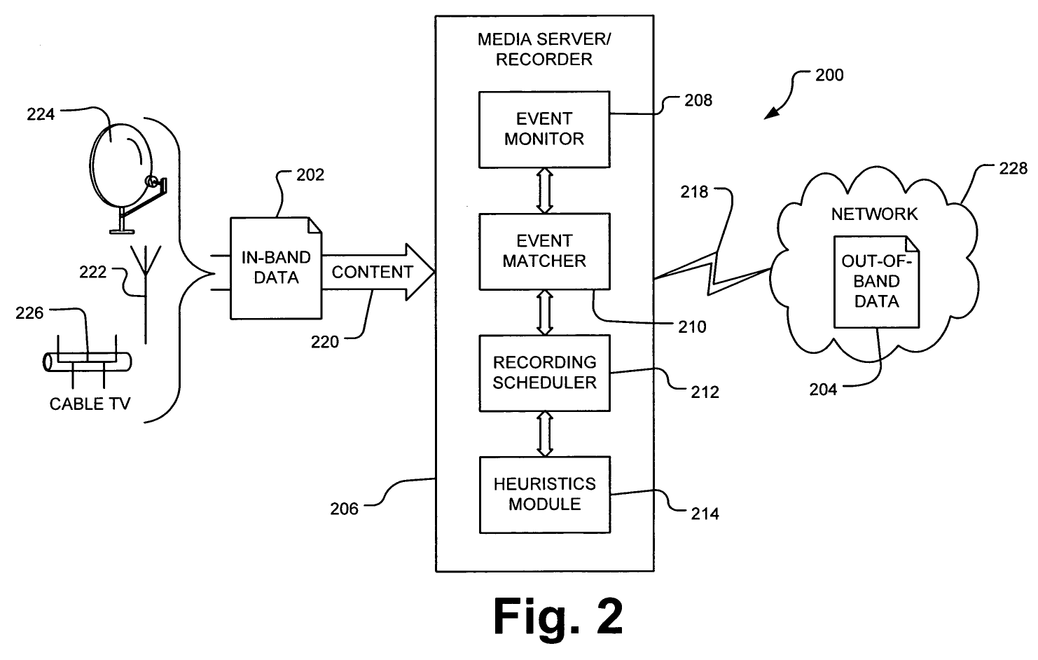

FIG. 2 depicts an overview of a system 200 incorporating a media server or media recorder 206 of the types described with respect to the entertainment system of FIG. 1. In the following description of FIGS. 2-4, it is to be understood that a media server 108 can provide the described functionality independently or in combination with an associated media recorder 106. Thus, for ease of description the term “media recorder” is used below to refer to functions performed by either or both of a media recorder 106 or a media server 108 depending upon the particular system configuration. The media recorder 206 provides for automatic extension of the recording of a programming event that extends beyond its scheduled time period. The processor and memory on the media recorder 206 may instantiate several functions that may be viewed as modules for performing specific tasks. An event monitor module 208 may be understood as a component that monitors the status of broadcast programs in real time by analyzing both in-band data 202 and out-of-band data 204 related to a particular program event. An event matcher module 210 may be understood as a component that identifies broadcast media events that have been selected for recording by user and then correlates or matches real-time data from the event monitor 208 with programming identified for recording to thereby determine whether to extend the end time for recording any particular program. The event monitor module 208 and the event matcher module 210 may be either local to the media recorder 206 as shown in FIG. 2 or they could be remote as part of a service that sends the relevant information out-of-band to the media recorder 206 upon request or at scheduled intervals. This arrangement may be desirable for load balancing of local processing functions on the media recorder 206 and/or conservation of bandwidth on the communication network 218.

Additionally, a recording scheduler module 212 may be understood as a component that manages the recording functions of the media recorder 206 and causes the media recorder 206 to start and stop recording selected broadcast programming based upon both user input and real-time information received from the event matcher 210 or from a heuristics module 214. The heuristics module 214 manages conflicts between recording requests that arise due to the early or late program starts or broadcast extensions beyond the regularly scheduled period, which often happens with live events. The heuristics module 214 may consider a variety of inputs in to the system 200 for potentially adjusting the start or end times of a recording. These inputs may include, for example, one or more media feeds (e.g., cable 226, satellite 224, antenna 222, and streaming via a network 228); data streams in the media feed(s), in-band marker information; one or more collections of program guide data; one or more real-time data feeds containing event information; and a system clock or timer.

As shown in FIG. 2, the in-band data 202 may be transmitted to the media recorder 206 in conjunction with the programming content 220 available for viewing or recording. The programming content 220 and the corresponding in-band data 202 may come from any available broadcast transmission source, for example, via broadcast antenna 220, satellite transmission 224, or cable transmission 226. As will be discussed further herein, the in-band data 202 may include EPG information, header fields in data packets, data transmitted in vertical blanking intervals, or other known methods for transmitting media data in conjunction with programming content 220.

The out-of-band data 204 maybe received from or stored at a source accessible over a communication network 228 by the media recorder 206 over a network link 218. The network 228 may be the Internet or any public or private network available for access by the media recorder 206. The network link 218 maybe any wired or wireless connection to the media recorder 206 as is standard in the art. The out-of-band data 204 may include, for example, alternative sources of EPG information, real-time news sources, rich site summary (RSS) feeds, and other web services that may provide real-time data regarding a broadcast programming event.

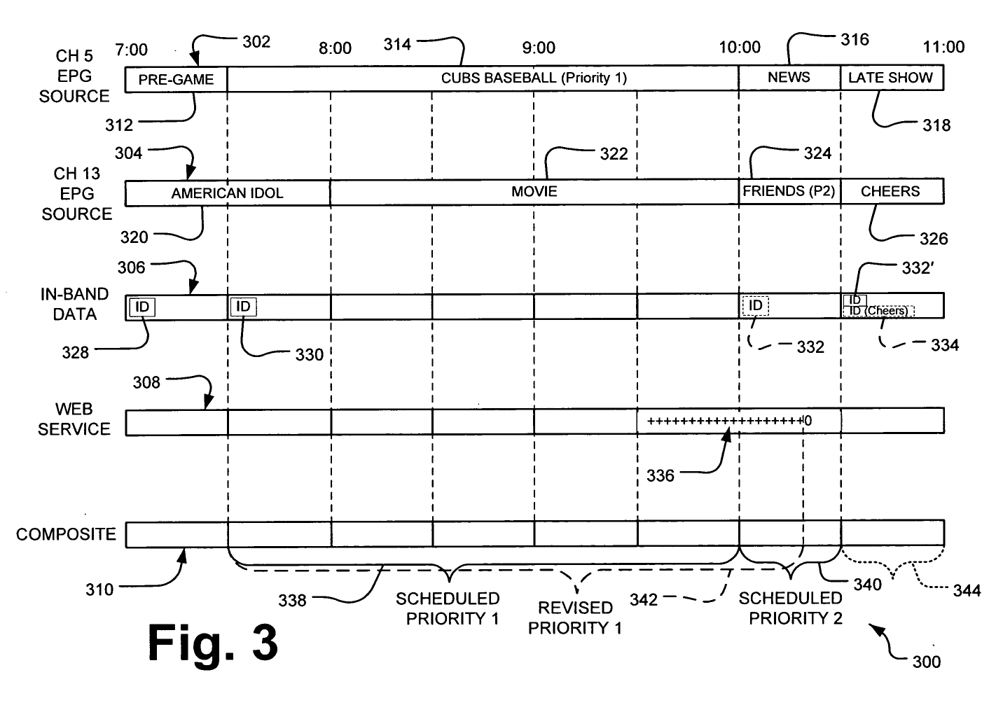

The actual functions performed by the modules on the media recorder 206 as discussed with respect to FIG. 2 to automatically extend recording periods may be understood in the context of a set of timelines 300 depicted in FIG. 3. The timelines 300 provide an example of how the recording time for a scheduled program maybe automatically extended, either at the beginning, the end, or both, through the monitoring of in-band and out-of-band data, end up with potential conflicts between competing recording requests may be resolved. The first timeline 302 represents data corresponding to programming scheduled for a particular channel as provided by an EPG source. In this example, the EPG source timeline 302 shows the programming scheduled for a particular evening on channel 5. The programming includes a pre-game show 312 occurring between 7:00 and 7:30, the broadcast of a Cubs baseball game 314 scheduled between 7:30 and 10:00, the local news 316 following the baseball game 314 at 10:00, and The Late Show 318 scheduled to begin at 10:30.

A second timeline 304 depicts an EPG schedule showing the programming scheduled for the same evening on channel 13. The programming includes an episode of American Idol 320 beginning at 7:00, followed by a movie 322 scheduled between 8:00 and 10:00, an episode of Friends 324 scheduled between 10:00 and 10:30, and an episode of Cheers 326 scheduled between 10:30 and 11:00. For the sake of illustration of the automatic recording extension methodologies disclosed herein, the diagram of FIG. 3 presumes that the user is interested in recording both the Cubs baseball programming 314 and the Friends episode 324.

A third timeline 306 depicts exemplary occurrences of in-band data broadcasting in conjunction with related programming content. A first program ID 328 is indicated as arriving in the broadcast transmission at the beginning of the pre-game program. In this example, the first program ID 328 may provide an indication that the pre-game program 312 is about to begin. A second program ID 330 may similarly provide information indicating that the broadcast of the Cubs baseball game 314 is about to begin. In this example, the first program ID 328 and the second program ID 330 are indicated as transmitted immediately proceeding or at the beginning of a particular broadcast program as an identifier of the programming about to follow. These types of program IDs at the outset of a particular program are fairly typical in broadcast programming and in digital program streams may be used to identify each packet of programming data transmitted.

A third program ID 332 is depicted in phantom in the in-band data timeline 304 and is shown as occurring at the beginning of the 10:00 time slot. This is where the program ID to indicate the beginning of the news 316 would appear if the baseball game 314 ended as scheduled. In this example, however, the baseball game 314 has run late and the third program ID 332′ is actually transmitted at the beginning of the 10:30 time slot to indicate the beginning of news 316. The event monitor module 208 may monitor the program IDs present in the broadcast transmission to identify the start of a new programming event. By using the programming ID information, the event matcher module 210 can confirm the start times of any particular program selected for recording based upon the schedule presented by EPG source. If, for example, the pre-game show 312 ends earlier than scheduled and the baseball game 314 starts earlier than scheduled, the program ID 330 corresponding to the beginning of the baseball game 314 may be considered a trigger for the recording scheduler module 214 to begin recording the baseball game 314 in advance of the scheduled start time. In a similar manner, the event matcher module 210 may use the program ID information at the beginning of a program transmission as indicator that the previous program transmission has concluded and that recording should stop.

Note, that in the case of FIG. 3, the third program ID 322′ is not received until 10:30, a half hour after the EPG source timeline 302 indicates that the baseball game will end. Thus if the media recorder 206 were to rely solely upon the EPG source for scheduling start and stop times for recording, the media recorder 206 may fail to record the end of the baseball game 314. However, if the media recorder 206 additionally considers in-band data, for example, the program ID data, the recording scheduler module 212 can adjust the stop time for recording the baseball game 314.

A fourth timeline 308 depicts exemplary out-of-band data received for example from a web service. The web service 308 may provide contemporaneous information regarding changes to a programming schedule or information about events that may have an impact on a particular programming schedule. In this example, with respect to a sporting event such as the baseball game 314, which are notorious for extending beyond a reasonably anticipated length of time, the web service maybe in the form of a sports feed that monitors all sporting events to provide subscribers up to the minute scores and announcements of final scores at the end of the game. One scenario the event monitor module 208 in the media recorder 206 may receive a direct feed from such a web service 308. In another scenario, the event monitor module may be configured to request such information from a central source on the network that subscribes to the web service 308.

As shown in FIG. 3, the web service information 336 maybe solicited or monitored by the event monitor module 208 during a period immediately proceeding the scheduled end time of the programming event being recorded and extending until confirmation of the conclusion of the event is received. In this example, the web service data 336 indicates that the baseball game 314 is still continuing even after 10:00 and ultimately ends at some point between 10:00 and 10:30. The “+” signs indicate receipt of web service data 336 related to the baseball game 314 and confirming continuing play while the “0” indicates the web service data 336 no longer indicates an ongoing game. When the event monitor module 208 receives information that the baseball game 314 has indeed concluded, this information may be provided to the recording scheduler module 212 by the event matcher module 210 causing the recording scheduler module 212 to cease recording on that channel.

The fifth timeline 310 in FIG. 3 depicts possible recording scenarios by the media recorder 206 based upon a composite analysis of all of the information available in the EPG source timelines 302, 304, the in-band data timeline 306, and the web service timeline 308 providing data out-of-band. As shown in the composite timeline 310, a first scheduled recording period 338 corresponds to the Cubs baseball game 314, which is the user's first priority. The user's second priority for recording is the Friends episode 324, which is marked as a second scheduled recording period 340. As indicated in the composite timeline 310, when the Cubs baseball game 314 extends beyond the scheduled time slot as indicated by an extended recording period 342, a conflict exists between the extended recording period 338 for the first priority program and the second recording period 340 for the user's second priority program.

By using the collective data exemplified by the EPG source timelines 302, 304, the in-band data timeline 306, and the web service timeline 308, in conjunction with a set of rules of governing conflicts between program recording, a conflict arising due to a scheduled program running long, such as the baseball game 314, can be managed. For example, in FIG. 3 where the user has pre-assigned priority levels between multiple recording requests, the recording scheduler 212 may automatically select which program to record. In this example, the baseball game 314 was given a higher priority as compared to the Friends episode 324, which was given a lower priority. In this instance, if the baseball game 314 exceeds the allotted time period, the revised extended recording period 342 may extend until the conclusion of the baseball game 314.

In another embodiment, wherein the priority between recording requests has not been pre-assigned, the media recorder 206 may present a UI with a request for the user to select which of two competing recording requests should be honored. If the conflict is resolved in favor of the programming that is extending beyond its scheduled time period, the recording scheduler module 212 may end the recording based upon either the in-band data, in this example the occurrence of a program ID indicating the start of a new program, or on the web service data.

In a further exemplary scenario, the recording of a first program with a first priority may be extended in favor of a second program, lower priority program scheduled for recording immediately after the scheduled end time of the first program. However, the first program may not be further extended when conflicting with a third program scheduled for recording after the second program, but having a higher priority than the first program.

The choice between using program ID data or web service data to dictate the cessation of recording may be determined by following a set of rules provided in the heuristics module 214. For example, the web service may indicate that a particular event, such as the baseball game 314, has not been completed while the in-band data shows the occurrence of a program ID 332 at 10:00 indicating the start of new program. In one implementation, the heuristics module 214 may choose to abide by the program ID data and stop the recording under the presumption that, although the event may still be occurring, the broadcast network may have stopped its presentation of the event in favor of some other regularly scheduled programming. Alternatively, the rules in the heuristics module 214 may provide that any web service information 336 received be given priority over any program IDs to ensure that the entire length of the priority program period 342 is recorded so that nothing is missed in case the program ID in the in-band data was inaccurate.

In the example above, the heuristics module 214 governing the recording scheduler module 212 placed priority on the web services information 336 and extended the recording of the baseball game 314, even though it overlapped with the Friends episode 324. However, consider another possible scenario in which the Friends episode 324 actually follows the baseball game 314 on the same channel instead of on a different channel. As indicated earlier, in addition to desiring to record the baseball game 314, the user also desires to record the Friends episode 324. By monitoring the program IDs, the event monitor module 208 may provide the recording scheduler module 212 some flexibility in determining whether additional programming should be recorded in the event that there is a schedule change. For example, in this case, the baseball game 314 has overrun the scheduled time period by up to a half hour based upon the location of the third program ID 332′ (which in this instance refers to the Friends episode 324 and not the news 316).

In another scenario, again in which the Friends episode 324 is on the same channel as the baseball game 314, if the baseball game 314 extends into the timeslot originally scheduled for the Friends episode 324, it may be that the Friends episode 324 will be cancelled entirely by the broadcaster. This can be confirmed if the third program ID 334 indicates that the programming starting at 10:30 is indeed the Cheers episode 326. However, in an alternate scenario, the broadcaster may desire to shift the entire programming schedule back by a half hour, and therefore the Friends episode 324 might in fact be broadcast beginning at 10:30. This again could be confirmed if the third program ID 332′ indicated that the associated program was the Friends episode 324. In this instance, the event matcher module 210 may provide this information to the recording scheduler module 212 and thus cause the recording scheduler module 212 to initiate the recording of the Friends episode 324 at 10:30 after the conclusion of the Cubs baseball game 314.

In this instance, the event monitor module 208 may continue to monitor the program IDs in the in-band data timeline 306 to determine whether the Friends episode 324 has been wholly preempted or merely pushed back to the next time slot. If the program ID 332′ indicates that the programming in the time slot following the baseball game 314 is indeed the Friends episode 324, then the recording scheduler module 212 will cause the media recorder 206 to record the Friends episode 324 during a shifted recording period 344.

As indicated above and shown in FIG. 2, a heuristics module 214 may be used to determine recording priorities between conflicting recording requests that arise due to the early or late start or extended broadcast of a programming event. As described above, the heuristics module 214 may consider a variety of data to determine whether to adjust the start or end times of a recording including the broadcast transmissions (e.g., cable, satellite, antenna, and network streaming); data streams in the media feed(s), in-band marker information; electronic program guide data; real-time data feeds (e.g., RSS) containing event information; and a system clock or timer. Each of the inputs may have a different data type and format. Each data input may further be assigned a specific associated weight or priority so that the components processing the inputs can make decisions regarding the probable start and end time for the event.

As one example, an in-band marker may show that an event is running five minutes long (8:05 PM) whereas the real-time feeds when checked by the event monitor module 208 at 8:05 PM show the event is still running. In this case the heuristics module 214 may review the weights of the inputs and decide to prefer the five minute extension rather than the six or more minute extension due to the weighting. This is just one very simple example of using an assignable weighting/priority system to deal with differences in the input data. Other approaches considered include choosing the most conservative data to ensure the fullest recording of the media; choosing the most aggressive data to conserve free space; and following an algorithm for comparing the input data for consistency patterns using frequency and weighting.

Possible methods for dynamically adjusting the recording start and end times may include, for example, revising or estimating new start and/or end times, providing an “in progress” notification; and extending the recording period by some amount of time, either fixed (e.g., a delta from the originally scheduled end) or variable. To further elaborate on the “in progress” indication example, the sources for this method may, in general, be polled or come in on regular intervals. In this case there is a need to extend the recording by some amount greater than the poll interval to ensure that the recording will not be stopped due to lack of data before the most recent update. The data source(s) could also potentially be polled before the scheduled start time to cover the case of a program beginning before its scheduled start time.

The heuristics module 214 may request user input upon set-up of any rules or weighting scheme and incorporate the user input into the decisions. For example the user could potentially want any of the following: the earliest start time and latest end time; the scheduled start time and latest end time; the latest start time and latest end time; the latest end time that does not overlap higher priority recordings; or the latest end time that does not go past a reasonable duration (a “dead-man switch”). Additionally, if the user is present, the heuristics module 214 could present a UI indicating the potential conflict and ask the user to make a contemporaneous decision. Alternatively, if the user is not present or does not respond in a timely manner, the heuristics module 214 would take over and resolve the conflict based upon the data received, a default hierarchy between conflicting data sources, and any preset user input.

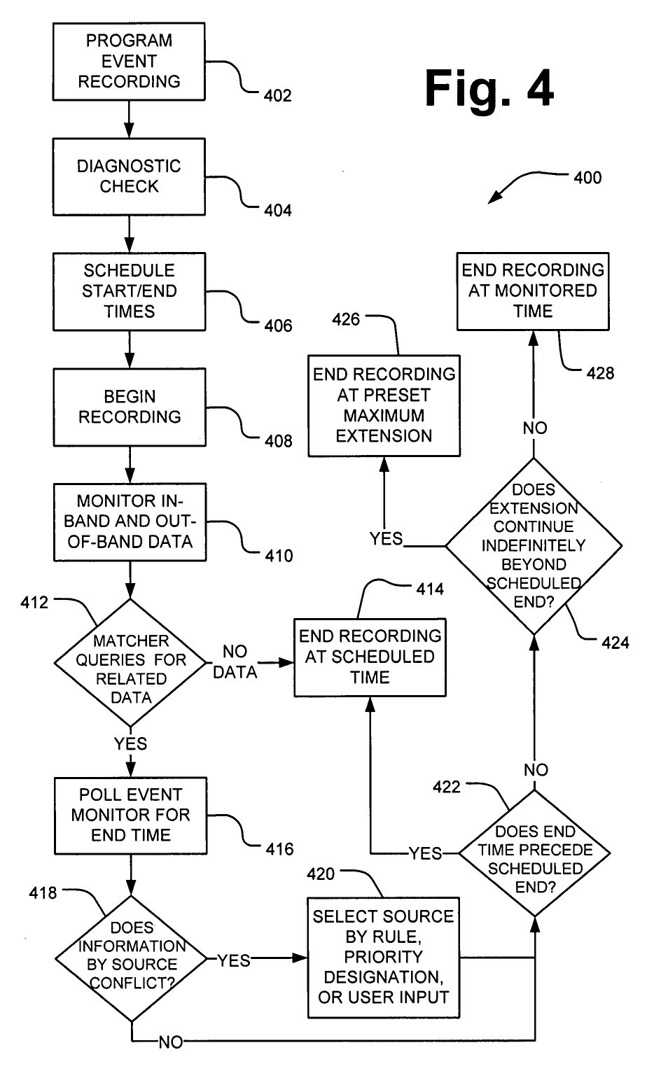

An exemplary set of heuristics or rules 400 performed under the direction of the heuristics module 214 for automatically extending the scheduled recording time of an event is depicted in FIG. 4. Note that similar rules can be implemented to determine whether to advance or delay the start of program recording or end the recording of a program early. In a programming operation 402, the media recorder 206 is programmed for the recording of an event by a user. Next, in a diagnostic operation 404, a diagnostic check of media recorder hardware and recording schedules is performed. For example, the hard drive of the media recorder 206 maybe accessed to determine whether there is enough space on the hard drive to record the scheduled length of the program. Additionally, the recording schedules maybe reviewed to determine whether there are any scheduling conflicts between other programs that were previously scheduled for recording.

Once the diagnostic operation 404 is completed, the recording scheduler may schedule the start and end times for recording the selected programming in a scheduling operation 406. At this point, the scheduling operation 406 will resolve any scheduling conflicts noted during the diagnostic operation 404. Such scheduling conflicts can be resolved by requesting additional user input or by following a set of rules designed to resolve recording conflicts at the time of scheduling. At the scheduled start time the media recorder 206 will begin recording in recording operation 408. While recording of the programming is in progress, the event monitor module 208 monitors in-band and out-of-band data received by the media recorder 206. As the monitoring operation 410 receives new in-band or out-of-band data, a query operation 412 is performed by the event matcher module 210 during the recording of the programming event to determine whether any of the in-band or out-of-band data received by the event monitor module 208 is related to the event being recorded. If, during the course of the programming event, no in-band or out-of-band data related to the programming event is received at the media recorder 206, then the recording scheduler module 212 will end the recording of the programming at the originally scheduled time in ending operation 414.

Alternately, if the event matcher module 210 does identify in-band or out-of-band data related to the present programming event being recorded, the event matcher module 210 will poll the event monitor module regularly for updated information regarding the end time in polling operation 416. The heuristics module 214 may further analyze the in-band data 202 and out-of-band data 204 to determine whether information from different sources indicates a conflict period in the context of FIG. 3. For example, the heuristics module 214 may compare program ID information received in-band with web services information received out-of-band. Next, in the query operation 418, if it is determined that there is a conflict, then the heuristics module 214 may select the programming to record based upon a rule scheme, priority designations allocated between competing programming, and/or by directly soliciting input from the user to resolve a conflict as indicated in selecting operation 420. Once the selection is made, the process continues to query operation 422. Similarly, if there is no conflict in query operation 418, the process also continues to query operation 422.

At this point the process 400 may determine whether the end time indicated by the in-band or out-of-band data precedes the originally scheduled end time in query operation 422. If the revised end time does proceed the scheduled end time, the process 400 may continue recording and end the recording at the originally scheduled end time in ending operation 414. This may ensure that all of the desired programs are recorded in the instance that the in-band data 202 or out-of-band data 204 is inaccurate.

If the revised end time extends beyond the scheduled end time as determined in query operation 422, a further query operation 424 may be undertaken to determine whether the extension of the recording time is unduly excessive. There may be an occasion where the in-band data 202 or out-of-band data 204 is inaccurate and fails to indicate the end of the program after initially indicating that the program would extend beyond the scheduled end time. At some point (perhaps other than a baseball game, which can extend into numerous extra innings) after the originally scheduled end time, the greater likelihood is that the program being recorded has ended.

The heuristics module 214 may determine that the extension period is unreasonable based upon a variety of factors and circumstances, for example, the type of programming (e.g., baseball vs. a symphony concert); the percentage of the scheduled recording period that the extension period has extended; and the presence or absence of in-band data 202 or out-of-band data 204 continuing to indicate the broadcast of the programming being recorded. If the heuristics module 214 determines that the extension period is excessive, unreasonable, or not supported by the current data, the recording scheduler module 212 may be instructed to override any prior extension instruction end recording, for example, at a predefined absolute maximum extension time or a maximum percentage of the originally scheduled recording time. Alternatively, the heuristics module 214 may request that the user make a determination whether to stop recording through a UI query. If the heuristics engine determines that the extension period is not excessive or the data continues to appear to be accurate, the recording scheduler module 212 may end the program recording when the in-band data 202 and out-of-band data 204 ultimately indicate the end of the program in ending operation 428.

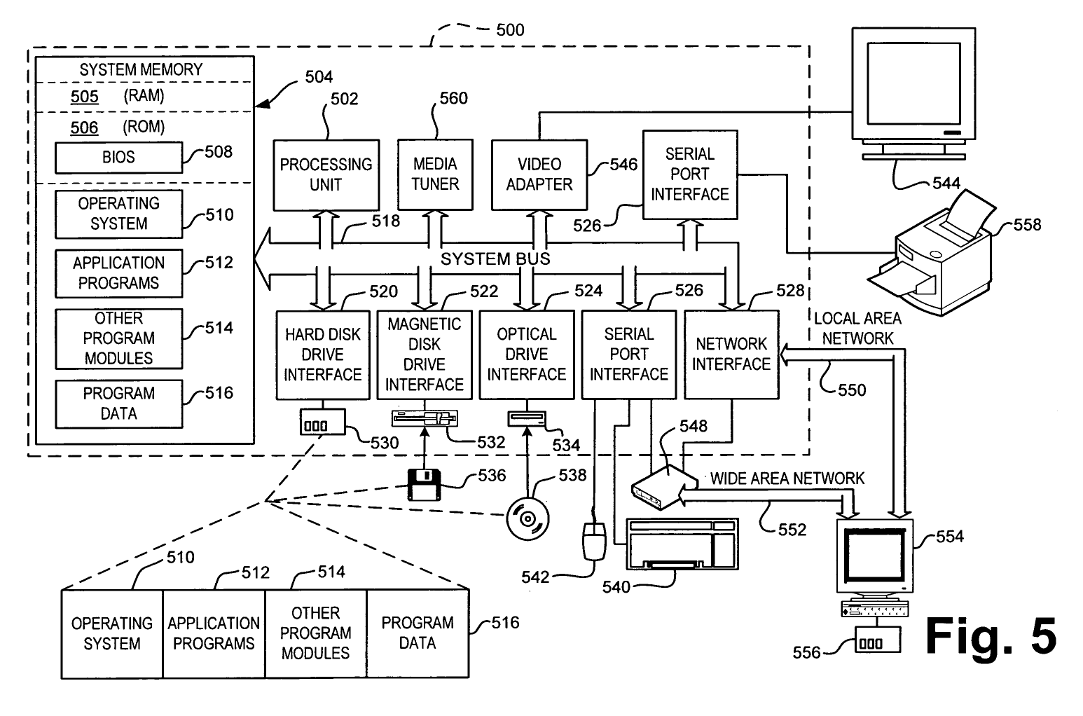

An exemplary hardware and operating environment in the form of a general purpose computing device 500 is depicted in FIG. 5. Any or all of the components of the computing device 500 may be incorporated the media recorder 106, or the media server 108 in order to provide the appropriate functionality for automatic extension of a scheduled recording period. The computing device 500 may typically include at least a processing unit 502, a system memory 504, and a system bus 518 that operatively couples various system components, including the system memory 504 to the processing unit 502. The computing device 502 may have one or more processing units 502, such that the processor of computer 500 comprises a single central processing unit (CPU), or a plurality of processing units, commonly referred to as a parallel processing environment. The computer 500 may be a conventional computer, a distributed computer, or any other type of computer; the invention is not so limited.

The system bus 518 may be any of several types of bus structures including a memory bus or memory controller, a peripheral bus, a switched fabric, point-to-point connections, and a local bus using any of a variety of bus architectures. The system memory 504 may also be referred to as simply the memory, and includes random access memory (RAM) 505 and read only memory (ROM) 506. A basic input/output system (BIOS) 508, containing the basic routines that help to transfer information between elements within the computer 500, such as during start-up, is stored in ROM 506. The computing device 500 further includes a hard disk drive 530 for reading from and writing to a hard disk (not shown), a magnetic disk drive 532 for reading from or writing to a removable magnetic disk 536, and an optical disk drive 534 for reading from or writing to a removable optical disk 538 such as a CD ROM, DVD, or other optical media.

The hard disk drive 530, magnetic disk drive 532, and optical disk drive 534 are connected to the system bus 518 by a hard disk drive interface 520, a magnetic disk drive interface 522, and an optical disk drive interface 524, respectively. The drives and their associated computer-readable media provide nonvolatile storage of computer-readable instructions, data structures, program modules, and other data for the computing device 500. It should be appreciated by those skilled in the art that any type of computer-readable media that can store data that is accessible by a computer, for example, magnetic cassettes, flash memory cards, digital video disks, RAMs, and ROMs, may be used in the exemplary operating environment.

A number of program modules may be stored on the RAM 505, ROM 506, hard disk 530, magnetic disk 532, or optical disk 534 including an operating system 510, one or more application programs 512, additional program modules 514, and program data 516. In an exemplary implementation, the, event monitor module, the event matcher module, and the recording scheduler module may be incorporated as part of the operating system 510, application programs 512, or other program modules 514.

A user may enter commands and information into the computing device 500 through input devices such as a keyboard 540 and pointing device 542, for example, a mouse. Other input devices (not shown) may include, for example, a remote control, a microphone, a joystick, a game pad, a tablet, a touch screen device, a satellite dish, a scanner, a facsimile machine, and a video camera. These and other input devices are often connected to the processing unit 502 through a serial port interface 526 that is coupled to the system bus 518, but may be connected by other interfaces such as a parallel port, game port, or a universal serial bus (USB).

A monitor 544 or other type of display device is also connected to the system bus 518 via an interface, such as a video adapter 546. In addition to the monitor 544, computers typically include other peripheral output devices, such as a printer 558 and speakers (not shown). These and other output devices are often connected to the processing unit 502 through the serial port interface 526 that is coupled to the system bus 518, but may be connected by other interfaces, such as a parallel port, game port, or a USB. A media tuner module 560 may also be connected to the system bus 518, a USB port, a 1394 (Firewire) port, or the local network 550 to tune audio and video programming (e.g., TV programming) for output through the video adapter 546 or other presentation output modules.

The computing device 500 may operate in a networked environment using logical connections to one or more remote computers, such as remote computer 554. These logical connections may be achieved by a communication device coupled to or integral with the computer 500. The logical connections depicted in FIG. 5 include a local-area network (LAN) 550 and a wide-area network (WAN) 552. Such networking environments are commonplace in office networks, enterprise-wide computer networks, intranets and the Internet, which are all types of networks. The remote computer 554 may be another computer, a server, a router, a network personal computer, a client, a peer device, or other common network node, and typically includes many or all of the elements described above relative to the computing device 500, although only a memory storage device 556 has been illustrated in FIG. 5.

When used in a LAN 550 environment, the computing device 500 may be connected to the local network 550 through a network interface or adapter 528, e.g., Ethernet or other communications interfaces, either directly or through a hub or router (not shown). When used in a WAN 552 environment, the computer 500 typically includes a modem 548, a network adapter, or any other type of communications device for establishing communications over the wide area network 552. The modem 548, which may be internal or external, may be connected to the system bus 518 via the serial port interface 526 or the network interface 528. In a networked environment, program modules depicted relative to the personal computer 500, or portions thereof, may be stored in a remote memory storage device. It is appreciated that the network connections shown are exemplary and other means of and communications devices for establishing a communications link between the computers may be used.

The technology described herein may be implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention. In particular, it should be understand that the described technology may be employed independent of a personal computer. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A method in a media presentation system for automatically extending a scheduled recording period for a program that may extend beyond an originally schedule broadcast period, the method comprising
receiving current program schedule information from a number of sources including an out-of-band source;
determining whether the current program schedule information is related to the program;
determining whether the program will extend beyond the originally schedule broadcast period based upon the current program schedule information;
determining a revised recording period for the program from the current program schedule information received; and
extending the scheduled recording period to follow the revised recording period to ensure the program will be recorded in its entirety.

2. The method of claim 1 further comprising determining a priority among the sources to indicate which of the sources should be followed when the current program schedule information differs among the sources.

3. The method of claim 2, wherein the priority determination operation is performed base upon a weighting scheme that allocates accuracy weights among the sources based upon a predetermined measure of quality among the sources.

4. The method of claim 1 further comprising
determining a recording conflict with a second recording period caused by the extension of the scheduled recording period; and
resolving the recording conflict by implementing a set of conflict rules that allocate priority between programs selected for recording.

5. The method of claim 4, wherein the resolving operation further comprises soliciting input from a user to resolve the conflict.

6. The method of claim 1 further comprising
reviewing the revised recording period for reasonableness pursuant to a set of rules; and
overriding the extending operation to end the program if the revised recording period is determined to be unreasonable under current circumstances according to the set of rules.

7. The method of claim 1, wherein the program is a broadcast of a live event and the out-of-band data comprises a service that provides real-time information over a communication network indicating whether the live event has or has not concluded.

8. The method of claim 1 further comprising updating an existing program schedule to account for the current program schedule information.

9. The method of claim 1 wherein the revised recording period begins in advance of the scheduled recording period.

10. The method of claim 1, wherein the revised recording period begins after a beginning of the scheduled recording period.

11. The method of claim 1, wherein the revised recording period extends beyond an end of the scheduled recording period.

12. A computer-readable medium having computer-executable instructions for controlling a media recording operation on a computer controlled recording device, the instructions comprising operations for causing the recording device to
receive current program schedule information from a number of sources including an out-of-band source;
determine whether the current program schedule information is related to the program;
determine whether the program will extend beyond the originally schedule broadcast period based upon the current program schedule information;
determine a revised recording period for the program from the current program schedule information received; and
extend the scheduled recording period to follow the revised recording period to ensure the program will be recorded in its entirety.

13. The computer-readable medium of claim 12, wherein the instructions further comprise operations for causing the recording device to determine a priority among the sources to indicate which of the sources should be followed when the current program schedule information differs among the sources.

14. The computer-readable medium of claim 12, wherein the instructions further comprise operations for causing the recording device to
determine a recording conflict with a second recording period caused by the extension of the scheduled recording period; and
resolve the recording conflict by implementing a set of conflict rules that allocate priority between programs selected for recording.

15. The computer-readable medium of claim 12, wherein the instructions further comprise operations for causing the recording device to
review the revised recording period for reasonableness pursuant to a set of rules; and
overriding the extending operation to end the program if the revised recording period is determined to be unreasonable under current circumstances according to the set of rules.

16. The computer-readable medium of claim 12, wherein the program is a broadcast of a live event and the out-of-band data comprises a service that provides real-time information over a communication network indicating whether the live event has or has not concluded.

17. A system for recording broadcast programming that automatically extends a scheduled recording period for a program that may run long, the system comprising
an event monitor module that receives current program schedule information from a number of sources including an out-of-band source;
an event matcher module that determines whether the current program schedule information is related to the program;
a heuristics module that determines whether the program will extend beyond the originally schedule broadcast period based upon the current program schedule information and determines a revised recording period for the program from the current program schedule information received; and
a recording scheduler module that extends the scheduled recording period to follow the revised recording period to ensure the program will be recorded in its entirety.

18. The system of claim 17, wherein the heuristics module further determines a priority among the sources to indicate which of the sources should be followed when the current program schedule information differs among the sources.

19. The system of claim 17, wherein the heuristics module further
determines a recording conflict with a second recording period caused by the extension of the scheduled recording period; and
resolves the recording conflict by implementing a set of conflict rules that allocate priority between programs selected for recording.

20. The system of claim 17, wherein the program is a broadcast of a live event and the out-of-band data comprises a service that provides real-time information over a communication network indicating whether the live event has or has not concluded.
